(19) United States
(12) Patent Application Publication
(10) Pub. No.: US 2009/0026425 A1
(43) Pub. Date: Jan. 29, 2009

(54) COMPOSITION COMPRISING POLYESTER AMIDE ACID AND THE LIKE AND INK-JET INK COMPOSITION USING THE SAME

(75) Inventors: Hiroyuki SATOU, Chiba (JP); Yoshihiro DEYAMA, Chiba (JP); Akira YAMAUCHI, Chiba (JP)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CHISSO CORPORATION, Osaka (JP)

(21) Appl. No.: 12/180,311

(22) Filed: Jul. 25, 2008

(30) Foreign Application Priority Data
Jul. 27, 2007 (JP) 2007-196230

(51) Int. Cl. C08L 67/00; C08L 77/00; C08L 57/00; C08L 83/00; C08L 63/00; C08L 63/02; G02B 5/23

(52) U.S. Cl. 252/586; 524/600; 524/538; 522/174; 524/502; 524/588; 523/400; 523/429; 523/427

(57) ABSTRACT

The invention provides a composition comprising a polyester amide acid (A) obtained by reacting a tetracarboxylic dianhydride (a1), a diamine (a2) and a multivalent hydroxy compound (a3); a pigment (B); and an epoxy resin (C), which is most suitable for an ink-jet ink composition for a color filter.

### CROSS REFERENCE TO RELATED APPLICATIONS

This application claims priority under 35 U.S.C. §119 to Japanese Patent Application No. JP 2007-196230, filed Jul. 27, 2007, which application is expressly incorporated herein by reference in its entirety.

### FIELD OF THE INVENTION

The invention relates to a composition comprising a polyester amide acid and the like, an ink-jet ink composition, a color filter produced using the ink composition, and a liquid crystal display device or a solid-state image sensing device comprising the color filter. A cured film formed using the ink composition by means of the ink-jet method is excellent in toughness and is suitable for a color filter.

### BACKGROUND OF THE INVENTION

As methods for forming a color filter for a color liquid crystal display device and the like, the photolithographic method, the printing method, the ink-jet method and the like can be employed. Currently, the photolithographic method is most popular. However, recently, as screens of display devices have been getting larger, much attention has been given to the ink-jet method from the viewpoint of less production processes and low costs.

However, when forming a color filter by means of the ink-jet method using a composition comprising a pigment and a polymer, it has the following drawbacks: the accuracy of liquid columns at the time of jetting is low; satellite ink drops are generated; it is difficult to provide a jet to an intended pixel; and red color, green color and blue color are mixed. Satellite ink drops are ink drops which are separated from the main ink drops and are discharged from a nozzle of an ink-jet head.

Color filters may be deteriorated, damaged or altered in the production processes of color liquid crystal display devices such as the ITO sputtering process and the aligning film-forming process, since the filters are treated with various chemicals such as organic solvent, acid, alkali solution and the like and surfaces thereof are locally heated at a high temperature. In order to improve chemical resistance and heat resistance, inkjet inks, in which an acrylamide-based polymer is blended, have been developed (see, e.g., Japanese Laid-Open Patent Publication No. Hei 8-171010). A technique, in which a silicon-containing polyamide acid composition is used as a protective film material for a color filter, has also been developed (see, e.g., Japanese Laid-Open Patent Publication No. Hei 9-291150).

Recently, as screens of color liquid crystal display devices have been getting larger, chemical resistance and heat resistance in each production process are more highly required, and further improvement thereof is desired. However, the above-described acrylic resin has the drawback that it begins to be decomposed when exposed to a high temperature of 200° C. or higher. in the case of the technique using the above-described protective film, the number of production processes is increased due to the necessity to form the protective film, and as a result, high production costs are concerned.

Under the above-described circumstances, a color filer which is excellent in heat resistance and toughness with a smaller number of production processes is desired. Further, an ink-jet ink composition, which can be used to obtain a cured film suitable for the color filter, is also desired.

### SUMMARY OF THE INVENTION

In order to solve the above-described problems, the inventors have diligently researched, found that a composition comprising a specific polyester amide acid and a pigment is excellent as the above-described ink-jet ink composition, and completed the invention. The invention provides the following composition and the like:

[1] A composition including a polyester amide acid (A) obtained by reacting a tetracarboxylic dianhydride (a1), a diamine (a2) and a multivalent hydroxy compound (a3); and a pigment (B).

[2] A composition including a polyester amide acid (A) obtained by reacting a tetracarboxylic dianhydride (a1), a diamine (a2) and a multivalent hydroxy compound (a3); a pigment (B); and an epoxy resin (C).

[3] The composition according to Item [1] or [2], further including a compound (D) having a polymerizable double bond; and a photopolymerization initiator (E).

[4] The composition according to any one of Items [1] to [3], further including a solvent (G) having a boiling point of approximately 200° C. or higher.

The composition according to any one of Items [1] to [4], wherein the polyester amide acid (A) is a reaction product obtained by further reacting a monovalent alcohol (a4) as a raw material.

[6] The composition according to any one of Items [1] to [5], wherein the polyester amide acid (A) is a reaction product obtained by further reacting a styrene-maleic anhydride copolymer (a5) and/or a silicon-containing monoamine (a6) as raw materials.

[7] The composition according to any one of Items [1] to [6], wherein the polyester amide acid (A) is obtained by reacting X moles of the tetracarboxylic dianhydride (a1), Y moles of the diamine (a2) and Z moles of the multivalent hydroxy compound (a3) in a ratio which satisfies relationships defined by the following mathematical formulae (1) and (2):

approximately 0.2≦Z/Y≦approximately 8.0 (1)

approximately 0.2≦(Y+Z)/X≦approximately 1.5 (2)

[8] The composition according to any one of Items [1] to [7], wherein the polyester amide acid (A) is a compound having constitutional units represented by the following structural formulae (1) and (2):

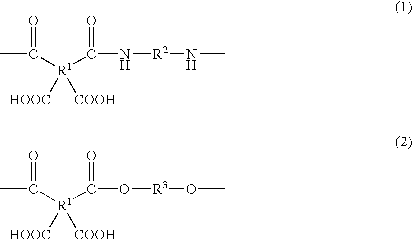

wherein R¹ is a residue of the tetracarboxylic dianhydride (a1), R² is a residue of the diamine (a2) and R³ is a residue of the multivalent hydroxy compound (a3).

[9] The composition according to any one of Items [2] to [8], wherein the epoxy resin (C) is one or more compound(s) selected from: a homopolymer of a monomer having an epoxy group; a copolymer of two or more monomers having an epoxy group; and a copolymer of a monomer having an epoxy group and a monomer having no epoxy group.

[10] The composition according to any one of Items [2] to [8], wherein the epoxy resin (C) is one or more compound(s) selected from: a bisphenol A type epoxy resin, a glycidyl ester type epoxy resin, an alicyclic epoxy resin, a glycidyl ether type epoxy resin, a bisphenol A novolac type epoxy resin, a phenol novolac type epoxy resin, a cresol novolac type epoxy resin, and a copolymer of a monomer having an epoxy group and a N-substituted maleimide compound.

[11] The composition according to any one of Items [2] to [8], wherein the epoxy resin (C) is a compound selected from: a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol; and 2-[4-(2,3-epoxy propoxy)phenyl]-2-[4-[1,1-bis[4-([2,3-epoxy propoxy]phenyl)]ethyl]phenyl]propane.

12] The composition according to any one of Items [1] to [11], wherein the composition is an ink-jet ink composition.

[13] A color filter produced using the ink-jet ink composition according to Item [12].

[14] A liquid crystal display device including the color filter according to Item [13].

[15] A solid-state image sensing device including the color filter according to Item [13].

The composition of the invention comprising a polyester amide acid and the like can be used for an ink-jet ink composition, which has ink-jetting suitability. Further, a color filter obtained by curing the ink-jet ink composition is excellent in toughness, and chemical resistance and heat resistance can be improved. Moreover, by utilizing the ink-jet ink composition of the invention, outgas is reduced, and thereby influence on a liquid crystal composition can be reduced. As a result, a color liquid crystal display device having high reliability can be provided.

### DETAILED DESCRIPTION OF THE INVENTION

1. Ink-Jet Ink Composition

The ink-jet ink composition comprises a polyester amide acid (A) obtained by reacting a tetracarboxylic dianhydride (a1), a diamine (a2) and a multivalent hydroxy compound (a3); and a pigment (B).

According to need, the inkjet ink composition may comprise an epoxy resin (C), and may also comprise a compound (D) having a polymerizable double bond; and a photopolymerization initiator (E). Moreover, according to need, the ink-jet ink composition may comprise a solvent (G), preferably a solvent (G) having a boiling point of approximately 200° C. or higher.

The above-described polyester amide acid (A) may be a reaction product obtained by further reacting a monovalent alcohol (a4) as a raw material, and may be a reaction product obtained by further reacting a styrene-maleic anhydride copolymer (a5) and/or a silicon-containing monoamine (a6) as raw materials.

The suitable range of viscosity of the ink-jet ink composition at inkjet discharge temperatures is preferably from approximately 5.0 to approximately 40 mPa·s, more preferably from approximately 7.0 to approximately 30 mPa·s, and even more preferably from approximately 10 to approximately 20 mPa·s. Further, the suitable range of viscosity at approximately 25° C. is preferably from approximately 5.0 to approximately 200 mPa·s, more preferably from approximately 7.0 to approximately 160 mPa·s, and even more preferably from approximately 10 to approximately 100 mPa·s.

(1) Thermosetting Ink-Jet Ink Composition

Hereinafter, as one example of the above-described ink-jet ink composition, a thermosetting ink-jet ink composition will be explained. The thermosetting ink-jet ink composition comprises at least a polyester amide acid (A) and a pigment (B), and is excellent in ink-jet properties at the time of jetting. The curing principle of the composition includes, but is not limited to the following process: by heating, an amide acid and a carboxylic acid had by the polyester amide acid (A) are intramolecularly reacted, and/or an amide acid and a carboxylic acid intermolecularly placed in the polyester amide acid (A) are reacted, and thereby the composition is cured. After film forming, a color filter is excellent in color purity, heat resistance and chemical resistance.

It the case of the thermosetting ink-jet ink composition comprising the epoxy resin (C), ink-jet properties at the time of jetting are retained, and the curing principle of the composition includes, but is not limited to the following process: by heating, a carboxylic acid and the epoxy resin (C) had by the polyester amide acid (A) are reacted. After film forming, color purity, heat resistance and chemical resistance of a color filter are further improved.

In this case, the ratio between A parts by weight of the polyester amide acid (A), B parts by weight of the pigment (B) and C parts by weight of the epoxy resin (C) preferably satisfies the relationship defined in the following mathematical formulae (3) and (4). In these ranges, the composition has good ink-jet properties at the time of jetting, and realizes a good balance between color purity, heat resistance and chemical resistance of a color filter after film forming.

approximately 0.05≦B/(A+C)≦approximately 5.0 (3)

approximately 0.02≦C/A≦approximately 4.0 (4)

“B/(A+C)” in mathematical formula (3) is more preferably approximately 0.1 to approximately 3.0, and still more preferably approximately 0.5 to approximately 2.0. “C/A” in mathematical formula (4) is more preferably approximately 0.05 to approximately 3.0, and still more preferably approximately 0.1 to approximately 2.0.

As another additive, a coupling agent can be used in order to improve adhesiveness to substrates. Per approximately 100 parts by weight of the solid content of the above-described ink-jet ink composition, preferably approximately 0 to approximately 20 parts by weight, more preferably approximately 0 to approximately 10 parts by weight, and still more preferably approximately 0 to approximately 5 parts by weight of the coupling agent can be used to be added thereto.

Further, a surfactant can be used in order to improve wettability with respect to substrates. Per approximately 100 parts by weight of the solid content of the above-described ink-jet ink composition, preferably approximately 0.01 to approximately 5 parts by weight, more preferably approximately 0.01 to approximately 1 parts by weight, and still more preferably approximately 0.01 to approximately 0.5 parts by weight of the surfactant can be used to be added thereto.

Moreover, an antioxidant can be used in order to improve transparency and to prevent yellowing when a color filter is exposed to high temperature conditions. Per approximately 100 parts by weight of the solid content of the above-described ink-jet ink composition, preferably approximately 0 to approximately 10 parts by weight, more preferably approximately 0 to approximately 3 parts by weight, and still more preferably approximately 0 to approximately 1 parts by weight of the antioxidant can be used to be added thereto.

(2) Photosetting Ink-Jet Ink Composition

Hereinafter, as another example of the above-described ink-jet ink composition, a photosetting ink-jet ink composition will be explained. The photosetting ink-jet ink composition comprises at least a polyester amide acid (A), a pigment (B), a compound (D) having a polymerizable double bond and a photopolymerization initiator (E), and has excellent ink-jet properties at the time of jetting. The polymerization/curing principle of the composition includes, but is not limited to the following process: by light irradiation, the compound (D) having a polymerizable double bond is polymerized using the photopolymerization initiator (E) as an initiator; and after that, by heating, an amide acid and a carboxylic acid had by the polyester amide acid (A) are intramolecularly reacted, and/or an amide acid and a carboxylic acid intermolecularly placed in the polyester amide acid (A) are reacted, and thereby the composition is cured. After film forming, a color filter is excellent in color purity, heat resistance and chemical resistance.

It the case of the photosetting ink-jet ink composition comprising the polyester amide acid (A), the pigment (B), the epoxy resin (C), the compound (D) having a polymerizable double bond and the photopolymerization initiator (E), ink-jet properties at the time of jetting are retained. The polymerization/curing principle of the composition includes, but is not limited to the following process: by light irradiation, the compound (D) having a polymerizable double bond is polymerized using the photopolymerization initiator (E) as an initiator; and after that, by heating, a carboxylic acid and the epoxy resin (C) had by the polyester amide acid (A) are reacted. After film forming, color purity, heat resistance and chemical resistance of a color filter are further improved.

In this case, the ratio between A parts by weight of the polyester amide acid (A), B parts by weight of the pigment (B), C parts by weight of the epoxy resin (C) and D parts by weight of the compound (D) having a polymerizable double bond preferably satisfies the relationship defined in the following mathematical formulae (5) to (7). In these ranges, the composition has good ink-jet properties at the time of jetting, and realizes a good balance between color purity, heat resistance and chemical resistance of a color filter after film forming.

approximately 0.05≦B/(A+C+D)≦approximately 5.0 (5)

approximately 0.02≦(C+D)/A≦approximately 4.0 (6)

approximately 0.1≦C/D≦approximately 4.0 (7)

“B/(A+C+D)” in mathematical formula (5) is more preferably approximately 0.1 to approximately 3.0, and still more preferably approximately 0.5 to approximately 2.0. “(C+D)/A” in mathematical formula (6) is more preferably approximately 0.05 to approximately 3.0, and still more preferably approximately 0.1 to approximately 2.0. “C/D” in mathematical formula (7) is more preferably approximately 0.5 to approximately 3.0, and still more preferably approximately 1.0 to approximately 2.0.

Per 100 parts by weight of the compound (D) having a polymerizable double bond, preferably approximately 0.1 to approximately 50 parts by weight, more preferably approximately 0.5 to approximately 30 parts by weight, and still more preferably approximately 1.0 to approximately 20 parts by weight of the photopolymerization initiator (E) can be used to be added thereto.

As other additives, a coupling agent, a surfactant, an antioxidant and the like can be used. The adding amounts of the additives are as described above regarding the thermosetting ink-jet ink composition.

1.1. Polyester Amide Acid (A)

A polyester amide acid (A) is obtained by reacting a tetracarboxylic dianhydride (a1), a diamine (a2) and a multivalent hydroxy compound (a3) as raw materials. It can also be obtained by further reacting a monovalent alcohol (a4). Moreover, it can also be obtained by further reacting a styrene-maleic anhydride copolymer (a5) and/or a silicon-containing monoamine (a6) as raw materials.

At least a solvent is necessary for synthesis of the polyester amide acid (A). The solvent may be retained to provide a liquid-type or gel-type composition in view of handling ability and the like. The solvent may be removed to provide a solid-type composition in view of transportability and the like.

1.1.1. Tetracarboxylic Dianhydride (a1)

Specific examples of the tetracarboxylic dianhydrides (a1) used for the polyester amide acid (A) include: aromatic tetracarboxylic dianhydrides such as 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenylether tetracarboxylic dianhydride, 2,2′,3,3′-diphenylether tetracarboxylic dianhydride, 2,3,3′,4′-diphenylether tetracarboxylic dianhydride, 2,2-[bis(3,4-dicarboxyphenyl)]hexafluoropropanedianhydride, ethylene glycol bis (anhydrotrimellitate) (trade name: TMEG-100, manufactured by New Japan Chemical Co., Ltd.) and the like; alicyclic tetracarboxylic dianhydrides such as cyclobutanetetracarboxylic dianhydride, methylcyclobutanetetracarboxylic dianhydride, cyclopentanetetracarboxylic dianhydride, cyclohexanetetracarboxylic dianhydride and the like; aliphatic tetracarboxylic dianhydrides such as ethanetetracarboxylic dianhydride, butanetetracarboxylic dianhydride and the like; and the like.

Among the above-described examples, 3,3′,4,4′-diphenylsulfone tetracarboxylic dianhydride, 3,3′,4,4′-diphenylether tetracarboxylic dianhydride, 2,2-[bis(3,4-dicarboxyphenyl)]hexafluoropropanedianhydride, ethylene glycol bis(anhydrotrimellitate) (trade name: TMEG-100, manufactured by New Japan Chemical Co., Ltd.) and the like are preferred since color purity of the pigment is not easily affected thereby. 3,3′,4,4′-diphenylether tetracarboxylic dianhydride and 3,3′,4,4′-diphenylsulfone tetracarboxylic dianhydride and the like are particularly preferred.

1.1.2. Diamine (a2)

Specific examples of the diamines (a2) used for the polyester amide acid (A) include: 4,4′-diaminodiphenyl sulfone, 3,3′-diaminodiphenyl sulfone, 3,4′-diaminodiphenyl sulfone, bis[4-(4-aminophenoxy)phenyl]sulfone, bis[4-(3-aminophenoxy)phenyl]sulfone, bis[3-(4-aminophenoxy)phenyl]sulfone, [4-(4-amino phenoxy)phenyl][3-(4-aminophenoxy)phenyl]sulfone, [4-(3-aminophenoxy)phenyl][3-(4-amino phenoxy)phenyl]sulfone, 2,2-bis[4-(4-aminophenoxy)phenyl]hexafluoropropane and the like.

Among the above-described examples, 3,3′-diaminodiphenyl sulfone, bis[4-(3-aminophenoxy)phenyl]sulfone and the like are preferred since color purity of the pigment is not easily affected thereby. 3,3′-diaminodiphenyl sulfone and the like are particularly preferred.

1.1.3. Multivalent Hydroxy Compound (a3)

Specific examples of the multivalent hydroxy compounds (a3) used for the polyester amide acid (A) include ethylene glycol, diethylene glycol, triethylene glycol, tetraethylene glycol, polyethylene glycol having a molecular weight of 1,000 or less, propylene glycol, dipropylene glycol, tripropylene glycol, tetrapropylene glycol, polypropylene glycol having a molecular weight of 1,000 or less, 1,2-butanediol, 1,3-butanediol, 1,4-butanediol, 1,2-pentanediol, 1,5-pentanediol, 2,4-pentanediol, 1,2,5-pentanetriol, 1,2-hexanediol, 1,6-hexanediol, 2,5-hexanediol, 1,2,6-hexanetriol, 1,2-heptanediol, 1,7-heptanediol, 1,2,7-heptanetriol, 1,2-octanediol, 1,8-octanediol, 3,6-octanediol, 1,2,8-octanetriol, 1,2-nonanediol, 1,9-nonanediol, 1,2,9-nonanetriol, 1,2-decanediol, 1,10-decanediol, 1,2,10-decanetriol, 1,2-dodecanediol, 1,12-dodecanediol, glycerin, trimethylolpropane, pentaerythritol, dipentaerythritol, bisphenol A (trade name), bisphenol S (trade name), bisphenol F (trade name), diethanolamine, triethanolamine and the like.

Among the above-described examples, ethylene glycol, propylene glycol, 1,4-butanediol, 1,5-pentanediol, 1,6-hexanediol, 1,7-heptanediol, 1,8-octanediol and the like, which have superior solubility in solvents, are preferred. 1,4-butanediol, 1,5-pentanediol, 1,6-hexanediol and the like are particularly preferred.

1.1.4. Monovalent Alcohol (a4)

Specific examples of the monovalent alcohols (a4) used for the polyester amide acid (A) include methanol, ethanol, 1-propanol, isopropyl alcohol, allyl alcohol, benzyl alcohol, hydroxyethyl methacrylate, propylene glycol monoethyl ether, propylene glycol monomethyl ether, dipropylene glycol monoethyl ether, dipropylene glycol monomethyl ether, ethylene glycol monoethyl ether, ethylene glycol monomethyl ether, diethylene glycol monoethyl ether, diethylene glycol monomethyl ether, phenol, borneol, maltol, linalool, terpineol, dimethyl benzyl carbinol, 3-ethyl-3-hydroxymethyl oxetane and the like.

Among the above-described examples, isopropyl alcohol, allyl alcohol, benzyl alcohol, hydroxyethyl methacrylate, propylene glycol monoethyl ether and 3-ethyl-3-hydroxymethyl oxetane are preferred. In consideration of compatibility at the time of mixing a polyester amide acid produced using these substances and an epoxy resin, benzyl alcohol is more preferably used as the monovalent alcohol (a4).

1.1.5. Styrene-Maleic Anhydride Copolymer (a5)

In order to improve heat resistance and alkali resistance of the ink-jet ink composition, as a raw material for the polyester amide acid (A), a compound having 3 or more acid anhydride groups can be further added. Examples of compounds having 3 or more acid anhydride groups include styrene-maleic anhydride copolymer (a5). Regarding the ratio of components constituting the styrene-maleic anhydride copolymer (a5), the molar ratio of styrerne/maleic anhydride is preferably approximately 0.5 to approximately 4, and particularly preferably approximately 1 to approximately 3. Specific examples of the styrene-maleic anhydride copolymers (a5) include commercially-available products such as SMA3000P, SMA2000P and SMA1000P manufactured by Kawahara Yuka Co., Ltd.

1.1.6. Silicon-Containing Monoamine (a6)

In order to improve heat resistance of the ink-jet ink composition, as a raw material for the polyester amide acid (A), a silicon-containing monoamine (a6) can be further added. Specific examples of the silicon-containing monoamines (a6) include 3-aminopropyl trimethoxysilane, 3-aminopropyl triethoxysilane, 3-aminopropyl methyldimethoxysilane, 3-aminopropyl methyldiethoxysilane, 4-aminobutyl trimethoxysilane, 4-aminobutyl triethoxysilane, 4-aminobutyl methyldiethoxysilane, p-aminophenyl trimethoxysilane, p-aminophenyl triethoxysilane, p-aminophenyl methyldimethoxysilane, p-aminophenyl methyldiethoxysilane, m-aminophenyl trimethoxysilane, m-aminophenyl methyldiethoxysilane and the like. Among the above-described examples, 3-aminopropyl triethoxysilane and p-aminophenyl trimethoxysilane are preferred. 3-aminopropyl triethoxysilane is particularly preferred since it provides good heat resistance and acid resistance.

1.1.7. Compound (a7) Having One Acid Anhydride Group

According to need, the polyester amide acid (A) may contain a compound having one acid anhydride group.

By additionally using the compound having one acid anhydride group in the synthesis of the polyester amide acid (A), the weight-average molecular weight of the polyester amide acid (A) is reduced, and thereby the discharge accuracy of liquid columns at the time of jetting the ink-jet ink composition can be improved. Specific examples of the compounds having one acid anhydride group include trimellitic anhydride and phthalic anhydride.

1.1.8. Solvent to be Used in Polymerization Reaction (a8)

Specific examples of the solvents (a8) to be used in a polymerization reaction for obtaining the polyester amide acid (A) include ethylene glycol methyl ether, ethylene glycol ethyl ether, ethylene glycol n-propyl ether, ethylene glycol n-butyl ether, ethylene glycol phenyl ether, diethylene glycol methyl ether, diethylene glycol ethyl ether, diethylene glycol n-propyl ether, diethylene glycol n-butyl ether, diethylene glycol dimethyl ether, diethylene glycol methyl ethyl ether, diethylene glycol diethyl ether, propylene glycol methyl ether, propylene glycol ethyl ether, propylene glycol n-propyl ether, propylene glycol n-butyl ether, propylene glycol phenyl ether, dipropylene glycol methyl ether, dipropylene glycol ethyl ether, dipropylene glycol n-propyl ether, dipropylene glycol n-butyl ether, dipropylene glycol phenyl ether, dipropylene glycol dimethyl ether, dipropylene glycol methyl ethyl ether, dipropylene glycol diethyl ether, tripropylene glycol methyl ether, tripropylene glycol ethyl ether, tripropylene glycol n-propyl ether, tripropylene glycol n-butyl ether, tripropylene glycol phenyl ether, n-propyl acetate, n-butyl acetate, isobutyl acetate, ethylene glycol methyl ether acetate, ethylene glycol ethyl ether acetate, ethylene glycol n-propyl ether acetate, ethylene glycol n-butyl ether acetate, diethylene glycol methyl ether acetate, diethylene glycol ethyl ether acetate, diethylene glycol n-propyl ether acetate, diethylene glycol n-butyl ether acetate, diethylene glycol dimethyl ether acetate, diethylene glycol methyl ethyl ether acetate, diethylene glycol diethyl ether acetate, propylene glycol methyl ether acetate, propylene glycol ethyl ether acetate, propylene glycol n-propyl ether acetate, propylene glycol n-butyl ether acetate, dipropylene glycol methyl ether acetate, dipropylene glycol ethyl ether acetate, dipropylene glycol n-propyl ether acetate, dipropylene glycol n-butyl ether acetate, tripropylene glycol methyl ether acetate, tripropylene glycol ethyl ether acetate, tripropylene glycol n-propyl ether acetate, tripropylene glycol n-butyl ether acetate, tripropylene glycol phenyl ether acetate, propylene glycol diacetate, 1,3-butylene glycol diacetate, cyclohexanol acetate, 3-methoxy butyl acetate, triacetin, 3,5,5-trimethyl-2-cyclohexene-1-one, 1,3-dimethyl-2-imidazolidinone, methyl 3-methoxypropionate, ethyl 3-methoxypropionate, methyl 3-ethoxypropionate, ethyl 3-ethoxypropionate, ethyl lactate, cyclohexanone, N-methyl-2-pyrrolidone, N,N-dimethylacetamide and the like.

Among the above-described examples, diethylene glycol ethyl ether, diethylene glycol n-butyl ether, diethylene glycol methyl ethyl ether, propylene glycol phenyl ether, dipropylene glycol n-propyl ether, dipropylene glycol n-butyl ether, tripropylene glycol methyl ether, tripropylene glycol n-butyl ether, diethylene glycol ethyl ether acetate, diethylene glycol n-butyl ether acetate, propylene glycol methyl ether acetate, dipropylene glycol methyl ether acetate, 1,3-butylene glycol diacetate, triacetin, 1,3-dimethyl-2-imidazolidinone, methyl 3-methoxypropionate, N-methyl-2-pyrrolidone and the like are preferred since they provide high discharge accuracy of liquid columns at the time of jetting the ink-jet ink composition.

These solvents can be used solely. Further, two or more of these solvents can be used in combination as a combined solvent. Moreover, a solvent other than the above-described solvents can be mixed therewith at a ratio of approximately 30 wt % or less.

1.1.9. Synthesis Conditions for Polyester Amide Acid (A)

In the method for synthesizing the polyester amide acid (A), “X” moles of the tetracarboxylic dianhydride (a1), “Y” moles of the diamine (a2) and “Z” moles of the multivalent hydroxy compound (a3) are reacted in the above-described solvent (a8). The ratio between X, Y and Z is preferably determined to satisfy relationships defined in mathematical formulae (1) and (2) described below. Within the ranges described below, the polyester amide acid (A) has a high solubility in the solvent and has a high affinity to the pigment, and as a result, a color filter having excellent chemical resistance and heat resistance can be obtained.

approximately 0.2≦Z/Y≦approximately 8.0 (1)

approximately 0.2≦(Y+Z)/X≦approximately 1.5 (2)

The relationship defined in mathematical formulae (1) is preferably approximately 0.7≦Z/Y≦approximately 7.0, and more preferably approximately 1.3≦Z/Y≦approximately 7.0. The relationship defined in mathematical formulae (2) is preferably approximately 0.5≦(Y+Z)/X≦approximately 0.9, and more preferably approximately 0.7≦(Y+Z)/X≦approximately 0.8.

Even when the monovalent alcohol (a4), the styrene-maleic anhydride copolymer (a5) or the silicon-containing monoamine (a6) is further reacted therewith, basically, the relationships defined in the above-described mathematical formulae are preferably satisfied.

Per all the raw materials for reaction (approximately 100 parts by weight): preferably approximately 0 to approximately 50 parts by weight, more preferably approximately 0 to approximately 20 parts by weight of the monovalent alcohol (a4) is used; preferably approximately 0 to approximately 50 parts by weight, more preferably approximately 0 to approximately 30 parts by weight of the styrene-maleic anhydride copolymer (a5) is used; and preferably approximately 0 to approximately 50 parts by weight, more preferably approximately 0 to approximately 20 parts by weight of the silicon-containing monoamine (a6) is used.

When the polyester amide acid (A) has an acid anhydride group at its molecular end, the above-described monovalent alcohol (a4) can be added for a reaction according to need. When the polyester amide acid (A) is obtained by performing a reaction with the monovalent alcohol (a4) added, the compatibility with the epoxy resin is improved, the discharge accuracy of liquid columns at the time of jetting the ink-jet ink composition including them is improved, and generation of satellite ink drops is suppressed.

The order of adding raw materials for reaction to a reaction system is not particularly limited. For example, the tetracarboxylic dianhydride (a1), the diamine (a2) and the multivalent hydroxy compound (a3) can be simultaneously added to a reaction solvent. Alternatively, the diamine (a2) and the multivalent hydroxy compound (a3) are dissolved in the reaction solvent and thereafter the tetracarboxylic dianhydride (a1) is added thereto. Alternatively, the tetracarboxylic dianhydride (a1) and the diamine (a2) are reacted in advance and thereafter the multivalent hydroxy compound (a3) is added to the reaction product.

Further, the monovalent alcohol (a4) can be added simultaneously with the tetracarboxylic dianhydride (a1), or can be added after the reaction between the tetracarboxylic dianhydride (a1), the diamine (a2) and the multivalent hydroxy compound (a3) is completed. The styrene-maleic anhydride copolymer (a5) and the compound (a7) having one acid anhydride group are preferably added simultaneously with the tetracarboxylic dianhydride (a1). When the silicon-containing monoamine (a6) is reacted, it is preferred that, after the reaction of the tetracarboxylic dianhydride (a1), the diamine (a2) and the multivalent hydroxy compound (a3) is completed, the reaction solution is cooled to approximately 40° C. or less, and thereafter the silicon-containing monoamine (a6) is added to the reaction solution to be reacted at approximately 10 to approximately 40° C. for approximately 0.1 to approximately 6 hours.

100 parts by weight or more of the solvent (a8) is preferably used for polymerization reaction per 100 parts by weight of the tetracarboxylic dianhydride (a1), the diamine (a2) and the multivalent hydroxy compound (a3) in total for the purpose of smooth progress of the reaction. The reaction is preferably performed at approximately 40 to approximately 200° C. for approximately 0.2 to approximately 20 hours.

The polyester amide acid (A) thus synthesized comprises constitutional units represented by the aforementioned structural formulae (1) and (2). The terminus thereof is an acid anhydride group, an amino group or a hydroxyl group derived from the tetracarboxylic dianhydride (a1), the diamine (a2) or the multivalent hydroxy compound (a3), or is constituted by an added substance other than these compounds. In the structural formulae (1) and (2), R¹ is a residue of the tetracarboxylic dianhydride (a1), and is preferably an organic group having 2 to 30 carbon atoms. R² is a residue of the diamine (a2), and is preferably an organic group having 2 to 30 carbon atoms. R³ is a residue of the multivalent hydroxy compound (a3), and is preferably an organic group having 2 to 20 carbon atoms.

The weight-average molecular weight of the obtained polyester amide acid (A) is preferably approximately 1,000 to approximately 50,000, and more preferably approximately 1,000 to approximately 20,000. Within the ranges, the polyester amide acid (A) has good chemical resistance and heat resistance.

1.2. Pigment (B)

The pigment (B) is selected from organic pigments and inorganic pigments. Since color filters are required to have high color purity, chemical resistance and heat resistance, organic pigment, which are excellent in color purity, chemical resistance and heat resistance, are more preferred.

Examples of organic pigments include those having a color index number such as C. I. Pigment Red 177, C. I. Pigment Red 178, C. I. Pigment Red 202, C. I. Pigment Red 209, C. I. Pigment Red 254, C. I. Pigment Red 255, C. I. Pigment Green 7, C. I. Pigment Green 36, C. I. Pigment Blue 15, C. I. Pigment Blue 15:3, C. I. Pigment Blue 15:4, C. 1. Pigment Blue 15:6, C. I. Pigment Blue 16, C. I. Pigment Yellow 83, C. I. Pigment Yellow 128, C. I. Pigment Yellow 138, C. I. Pigment Yellow 139, C. I. Pigment Yellow 150, C. I. Pigment Violet 23, C. I. Pigment Orange 43, C. I. Pigment Black 1, C. I. Pigment Black 7 and the like.

Examples of inorganic pigments include titanium oxide, titanium black and carbon black. These inorganic pigments and organic pigments can be used solely or in combination.

1.3. Epoxy Resin (C)

The epoxy resin (C) comprises one or more compounds selected from: a homopolymer of a monomer having an epoxy group; a copolymer of two or more monomers having an epoxy group; and a copolymer of a monomer having an epoxy group and a monomer having no epoxy group.

Specific examples of monomers having an epoxy group include glycidyl(meth)acrylate and methyglycidyl(meth)acrylate.

Specific examples of monomers having no epoxy group include: (meth)acrylic acid, methyl(meth)acrylate, ethyl(meth)acrylate, isopropyl(meth)acrylate, butyl(meth)acrylate, i-butyl(meth)acrylate, t-butyl(meth)acrylate, cyclohexyl(meth)acrylate, benzyl(meth)acrylate, 2-hydroxyethyl(meth)acrylate, 2-hydroxypropyl(meth)acrylate, styrene, methyl styrene, chlormethyl styrene; and N-substituted maleimide compounds such as N-phenyl maleimide, N-cyclohexyl maleimide and the like.

Among the above-described examples, methyl(meth)acrylate, benzyl(meth)acrylate, n-butyl(meth)acrylate, 2-hydroxyethyl(meth)acrylate, styrene, N-phenyl maleimide, N-cyclohexyl maleimide and the like are more preferable, since a copolymer obtained has excellent compatibility with the polyester amide acid (A).

Regarding the ratio between a monomer having an epoxy group and a monomer having no epoxy group in a copolymer, the monomer having an epoxy group is preferably in an amount of 30 mole % or more, since it provides excellent chemical resistance. The monomer having an epoxy group is more preferably in an amount of 50 mole % or more.

The weight-average molecular weight of a homopolymer of a monomer having an epoxy group, a copolymer of two or more monomers having an epoxy group, or a copolymer of a monomer having an epoxy group and a monomer having no epoxy group is preferably from approximately 1,000 to approximately 100,000, and more preferably from approximately 1,000 to approximately 10,000. In the ranges, they provide excellent solubility to solvents, and the viscosity of the ink-jet ink composition comprising them is decreased. As a result, the accuracy of liquid columns at the time of jetting the ink-jet ink composition is improved, and generation of satellite ink drops is suppressed.

The epoxy resin (C) is not particularly limited as long as it has good compatibility with other components constituting the ink-jet ink composition. Preferred examples thereof include a bisphenol A type epoxy resin, a glycidyl ester type epoxy resin, an alicyclic epoxy resin, a glycidyl ether type epoxy resin, a bisphenol A novolac type epoxy resin, a phenol novolac type epoxy resin and a cresol novolac type epoxy resin.

Preferred specific examples of the epoxy resin (C) include polyglycidyl methacrylate, methyl methacrylate-glycidyl methacrylate copolymer, benzyl methacrylate-glycidyl methacrylate copolymer, n-butyl methacrylate-glycidyl methacrylate copolymer, 2-hydroxyethyl methacrylate-glycidyl methacrylate copolymer, styrene-glycidyl methacrylate copolymer, N-phenylmaleimide-glycidyl methacrylate copolymer and N-cyclohexylmaleimide-glycidyl methacrylate copolymer.

Other preferred specific examples of the epoxy resin (C) include: Epikote 807, Epikote 815, Epikote 825, Epikote 827, Epikote 828, Epikote 190P, Epikote 191P (trade names, manufactured by Yuka Shell Epoxy Co., Ltd.); Epikote 1004, Epikote 1256 (trade names, manufactured by Japan Epoxy Resins Co., Ltd.); TECHMORE VG3101L (trade name, manufactured by Mitsui Chemicals, Inc.); EPPN-501H, 502H (trade names, manufactured by Nippon Kayaku Co., Ltd.); JER 1032H60 (trade name, manufactured by Japan Epoxy Resins Co., Ltd.); JER 157S65, 157S70 (trade names, manufactured by Japan Epoxy Resins Co., Ltd.); EPPN-201 (trade name, manufactured by Nippon Kayaku Co., Ltd.); JER 152, 154 (trade names, manufactured by Japan Epoxy Resins Co., Ltd.); EOCN-102S, 103S, 104S, 1020 (trade names, manufactured by Nippon Kayaku Co., Ltd.); Celloxide 2021, EHPE-3150 (trade names, manufactured by Daicel Chemical Industries, Ltd.) and the like. Among them, TECHMORE VG3101L (trade name, manufactured by Mitsui Chemicals, Inc.) and the like are preferable since they provide good heat resistance.

Other preferred specific examples of the epoxy resin (C) include a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol, and 2-[4-(2,3-epoxy propoxy)phenyl]-2-[4-[1,1-bis[4-([2,3-epoxy propoxy]phenyl)]ethyl]phenyl]propane.

1.4. Compound (D) Having a Polymerizable Double Bond

The compound (D) having a polymerizable double bond is not particularly limited as long as it has one or more polymerizable double bond. The compound preferably has one or more (meth)acryloyl group.

Specific examples thereof include ethylene glycol di(meth)acrylate, diethylene glycol di(meth)acrylate, triethylene glycol di(meth)acrylate, tetraethylene glycol di(meth)acrylate, polyethylene glycol di(meth)acrylate, epichlorohydrin-modified ethylene glycol di(meth)acrylate, epichlorohydrin-modified diethylene glycol di(meth)acrylate, epichlorohydrin-modified triethylene glycol di(meth)acrylate, epichlorohydrin-modified tetraethylene glycol di(meth)acrylate, epichlorohydrin-modified polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, epichlorohydrin-modified propylene glycol di(meth)acrylate, epichlorohydrin-modified dipropylene glycol di(meth)acrylate, epichlorohydrin-modified tripropylene glycol di(meth)acrylate, epichlorohydrin-modified tetrapropylene glycol di(meth)acrylate, epichlorohydrin-modified polypropylene glycol di(meth)acrylate, trimethylolpropane tri(meth)acrylate, ethylene oxide-modified trimethylolpropane tri(meth)acrylate, propylene oxide-modified trimethylolpropane tri(meth)acrylate, epichlorohydrin-modified trimethylolpropane tri(meth)acrylate, ditrimethylolpropane tetra(meth)acrylate, glycerol acrylate methacrylate, glycerol di(meth)acrylate, glycerol tri(meth)acrylate, epichlorohydrin-modified glycerol tri(meth)acrylate, 1,6-hexanediol di(meth)acrylate, epichlorohydrin-modified 1,6-hexanediol di(meth)acrylate, methoxylated cyclohexyl di(meth)acrylate, neopentyl glycol di(meth)acrylate, hydroxypivalate neopentyl glycol di(meth)acrylate, caprolactone-modified hydroxypivalate neopentyl glycol di(meth)acrylate, diglycerin tetra(meth)acrylate, pentaerythritol tri(meth)acrylate, pentaerythritol tetra(meth)acrylate, stearic acid-modified pentaerythritol di(meth)acrylate, dipentaerythritol penta(meth)acrylate, alkyl-modified dipentaerythritol penta(meth)acrylate, alkyl-modified dipentaerythritol tetra(meth)acrylate, alkyl-modified dipentaerythritol tri(meth)acrylate, dipentaerythritol hexa(meth)acrylate, caprolactone-modified dipentaerythritol hexa(meth)acrylate, allylated cyclohexyl di(meth)acrylate, bis[(meth)acryloxy neopentyl glycol]adipate, 2,2-bis[4-((meth)acryloxy)phenyl]propane, (meth)acrylate, 2,2-bis[4-((meth)acryloxy polyethoxy)phenyl]propane, 2,2-bis[4-((meth)acryloxy)phenyl]methane, 2,2-bis[4-((meth)acryloxy polyethoxy)phenyl]methane, 2,2-bis[4-((meth)acryloxy)phenyl]sulfone, 2,2-bis[4-((meth)acryloxy polyethoxy)phenyl]sulfone, 1,4-butanediol di(meth)acrylate, 1,3-butylene glycol(meth)acrylate, dicyclopentanyl diacrylate, ethylene oxide-modified phosphoric acid di(meth)acrylate, ethylene oxide-modified phosphoric acid tri(meth)acrylate, caprolactone, ethylene oxide modified phosphoric acid di(meth)acrylate (i.e ethylene oxide modified and di(meth)acrylated caprolactone adduct of phosphoric acid), caprolactone, ethylene oxide modified phosphoric acid tri(meth)acrylate (i.e ethylene oxide modified and tri(meth)acrylated caprolactone adduct of phosphoric acid), epichlorohydrin-modified phthalic acid di(meth)acrylate, tetrabromobisphenol A di(meth)acrylate, triglycerol di(meth)acrylate, neopentyl glycol-modified trimethylolpropane di(meth)acrylate, tris[(meth)acryloxyethyl]isocyanurate, caprolactone-modified tris[(meth)acryloxyethyl]isocyanurate, (meth)acrylated isocyanurate, and urethane(meth)acrylate.

These compounds (D) having a polymerizable double bond can be used solely or in combination.

The compound (D) having a polymerizable double bond preferably comprises approximately 50 wt % or more of a compound having 2 to 20 (meth)acryloyl groups, since it provides high curing rate. The compound (D) having a polymerizable double bond more preferably comprises approximately 50 wt % or more of a compound having 4 to 20 (meth)acryloyl groups, since it provides higher curing rate.

Specific examples of compounds having 4 to 20 (meth)acryloyl groups include trimethylolpropane triacrylate, pentaerythritol triacrylate, pentaerythritol tetraacrylate, dipentaerythritol pentaacrylate, dipentaerythritol hexaacrylate, diglycerin tetraacrylate, isocyanuric acid ethylene oxide-modified triacrylate, and urethane(meth)acrylate.

1.5. Photopolymerization Initiator (E)

The photopolymerization initiator (E) is not particularly limited as long as it has characteristics in which radicals are generated by light. Specific examples thereof include benzophenone, Michler's ketone, 4,4′-bis(diethylamino)benzophenone, xanthone, thioxanthone, isopropyl xanthone, 2,4-diethylthioxanthone, 2-ethylanthraquinone, acetophenone, 2-hydroxy-2-methylpropiophenone, 2-hydroxy-2-methyl-4′-isopropylpropiophenone, 1-hydroxycyclohexylphenyl ketone, isopropyl benzoin ether, isobutyl benzoin ether, 2,2-diethoxyacetophenone, 2,2-dimethoxy-2-phenylacetophenone, camphorquinone, benzanthrone, 2-methyl-1-[4-(methylthio)phenyl]-2-morpholinopropane-1-one, 1,2-octadione, 1-[4-(phenylthio)-,2-(0-benzoyloxime), ethyl 4-dimethylaminobenzoate, isoamyl 4-dimethylaminobenzoate, 4,4′-di(t-butylperoxycarbonyl)benzophenone, 3,4,4′-tri(t-butylperoxycarbonyl)benzophenone, 2,4,6-trimethylbenzoyl diphenylphosphine oxide, 2-(4′-methoxystyryl)-4,6-bis(trichloromethyl)-s-triazine, 2-(3′,4′-dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)-4,6-bis(trichloromethyl)-s-triazine, 2-(4′-pentyloxystyryl)-4,6-bis(trichloromethyl)-s-triazine, 4-[p-N,N-di(ethoxycarbonylmethyl)]-2,6-di(trichloromethyl)-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-dimethylaminostyryl)benzoxazol, 2-(p-dimethylaminostyryl)benzthiazole, 2-mercaptobenzothiazole, 3,3′-carbonylbis(7-diethylaminocoumarin, 2-(o-chlorophenyl)-4,4′,5,5′-tetraphenyl-1,2′-biimidazole, 2,2′-bis(2-chlorophenyl)-4,4′,5,5′-tetrakis(4-ethoxycarbonylphenyl)-1,2′-biimidazole, 2,2′-bis(2,4-dichlorophenyl)-4,4′,5,5′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 3-(2-methyl-2-dimethylaminopropionyl)carbazole, 3,6-bis(2-methyl-2-morpholinopropionyl)-9-n-dodecylcarbazole, 1-hydroxycyclohexylphenylketone, bis(η⁵-2,4-cyclopentadiene-1-yl)-bis(2,6-difluoro-3-(1H-pyrrole-1-yl)-phenyl)titanium, 2-methyl-1-[4-(methylthio)phenyl]-2-morpholinopropane-1-one, 2-benzyl-2-dimethylamino-1-(4-morpholinophenyl)-butanone-1,3,3′,4,4′-tetra(t-butylperoxycarbonyl)benzophene, 3,3′,4,4′-tetra(t-hexylperoxycarbonyl)benzophenone, 3,3′-di(methoxycarbonyl)-4,4′-di(t-butylperoxycarbonyl)benzophenone, 3,4′-di(methoxycarbonyl)-4,3′-di(t-butylperoxycarbonyl)benzophenone, 4,4′-di(methoxycarbonyl)-3,3′-di(t-butylperoxycarbonyl)benzophenone, 1,2-octanedione, and 1-[4-(phenylthio)phenyl]-,2-(o-benzoyloxime).

Among the above-described examples, 2-methyl-1-[4-(methylthio)phenyl]-2-morpholinopropane-1-one, 2-benzyl-2-dimethylamino-1-(4-morpholinophenyl)-butanone-1,3,3′-di(methoxycarbonyl)-4,4′-di(t-butylperoxycarbonyl)benzophenone, 3,4′-di(methoxycarbonyl)-4,3′-di(t-butylperoxycarbonyl)benzophenone, 4,4′-di(methoxycarbonyl)-3,3′-di(t-butylperoxycarbonyl)benzophenone, 1,2-octanedione, 1-[4-(phenylthio)phenyl]-,2-(o-benzoyloxime) and the like are preferred.

These photopolymerization initiators (E) can be used solely or in combination.

1.6. Other Additives (F)

According to need, the ink-jet ink composition may contain additives (F) other than those described above without departing from the purpose of the invention. Examples of such other additives (F) include a coupling agent, a surfactant, an antioxidant, a light stabilizer, a processing stabilizer and the like.

The coupling agent is used, for example, in order to improve adhesiveness to a substrate. For example, silane-based, aluminum-based, titanate-based compounds and the like can be used as the coupling agent.

Specific examples of the coupling agents include: silane-based compounds such as 3-glycidoxypropyl dimethylethoxysilane, 3-glycidoxypropyl methyldimethoxysilane, 3-glycidoxypropyl methyldiethoxysilane, 3-glycidoxypropyl trimethoxysilane and the like; aluminum-based compounds such as acetalkoxy aluminum diisopropylate and the like; and titanate-based compounds such as tetraisopropyl bis(dioctylphosphite)titanate and the like. Among them, 3-glycidoxypropyl trimethoxysilane is preferable since it improves adhesiveness more effectively.

The surfactant is used, for example, in order to improve wettability with respect to a substrate. As the surfactant, silicon-based surfactants, acrylic surfactants, fluorine-based surfactants and the like are used. Specific examples of the surfactants include: silicon-based surfactants such as Byk-300, Byk-306, Byk-335, Byk-310, Byk-341, Byk-344, and Byk-370 (trade names, manufactured by BYK-Chemie GmbH) and the like; acrylic surfactants such as Byk-354, ByK-358, and Byk-361 (trade names, manufactured by BYK-Chemie GmbH) and the like; fluorine-based surfactants such as DFX-18, FTERGENT 250, and FTERGENT 251 (trade names, manufactured by Neos Company Limited) and the like.

The antioxidant is used, for example, in order to improve transparency and to prevent yellowing when a color filter is exposed to high temperature conditions. Hindered phenol-based antioxidants and the like can be used. Specific examples of the antioxidants include IRGANOX 1010, IRGANOX 1035, IRGANOX 1076, IRGANOX 1135, IRGANOX 1520L (trade names, manufactured by Ciba Specialty Chemicals) and the like.

The light stabilizer is used, for example, in order to capture harmful free radicals generated by ultraviolet energy and to prevent change of the color purity. Hindered amine-based light stabilizes and the like can be used. Specific examples of the light stabilizes include TINUVIN 111 FDL, TINUVIN 123, TINUVIN 144, TINUVIN 152, TINUVIN 292, TINUVIN 5100, TINUVIN 5050, TINUVIN 5060, TINUVIN 5151 (trade names, manufactured by Ciba Specialty Chemicals) and the like.

The processing stabilizer is used, for example, in order to prevent change of the color purity when a color filter is exposed to high temperature conditions. Phosphorus-based processing stabilizers and the like can be used. Specific examples of the processing stabilizers include IRGAFOS XP40, IRGAFOS XP60 (trade names, manufactured by Ciba Specialty Chemicals) and the like.

1.7. Solvent (G)

The solvent (G) is used, for example, in order to adjust the viscosity of the ink-jet ink composition. As the solvent (G), the solvent (a8) used in a polymerization reaction at the time of synthesizing the polyester amide acid (A) can be used. However, in order to decrease the frequency of nozzle clogging at the time of forming a color filter by jetting the inkjet ink composition, a solvent having a boiling point of approximately 200° C. or higher is particularly preferable.

Specific examples of the solvents include diethylene glycol ethyl ether, diethylene glycol n-butyl ether, propylene glycol phenyl ether, dipropylene glycol n-propyl ether, dipropylene glycol n-butyl ether, tripropylene glycol methyl ether, tripropylene glycol n-butyl ether, diethylene glycol ethyl ether acetate, diethylene glycol n-butyl ether acetate, dipropylene glycol methyl ether acetate, 1,3-butylene glycol diacetate, triacetin, 1,3-dimethyl-2-imidazolidinone, N-methyl-2-pyrrolidone and the like.

The solid content of the ink-jet ink composition is selected depending on the thickness of the film formed by means of the ink-jet method. Preferably approximately 5 to approximately 50 parts by weight of the solid content (the solvent: approximately 95 to approximately 50 parts by weight), more preferably approximately 5 to approximately 40 parts by weight of the solid content (the solvent: approximately 95 to approximately 60 parts by weight), and even more preferably approximately 5 to approximately 35 parts by weight of the solid content (the solvent: approximately 95 to approximately 65 parts by weight) is contained in approximately 100 parts by weight of the ink-jet ink composition.

2. Cured Film Formed by Means of the Ink-Jet Method Using the Ink-Jet Ink Composition

As described above, the thermosetting ink-jet ink composition comprises the polyester amide acid (A), the pigment (B) and the epoxy resin (C), and the composition can be obtained by homogeneously mixing and dissolving them. Depending on desired properties, the compound (D) having a polymerizable double bond, the photopolymerization initiator (E) or the solvent (G) can be further mixed therewith. Moreover, according to need, the coupling agent, the surfactant, the antioxidant or the like can be selectively added thereto. When adding the compound (D) having a polymerizable double bond and the photopolymerization initiator (E), the composition is preferably cured by light irradiation as in the case of the photosetting ink-jet ink composition.

Further, as described above, the photosetting ink-jet ink composition can be obtained by adding the compound (D) having a polymerizable double bond and the photopolymerization initiator (E) to the above-described thermosetting ink-jet ink composition and homogeneously mixing and dissolving them.

Using the ink-jet ink composition prepared as described above, the color filter can be formed, for example, by the following method: the ink-jet ink composition is discharged from a discharge head to the surface of a substrate to which a black matrix is provided by means of the ink-jet method to form a pixel portion; and after that, the pixel portion is cured by heating, or is polymerized by light and thereafter cured by heating.

When cured only by heating, the pixel portion can be heated (prebaked) using a hot plate, an oven or the like to obtain a cured film. Heating conditions vary depending on the type of each component and each blending ratio. In general, heating is performed at approximately 70 to approximately 120° C. for approximately 5 to approximately 15 minutes in an oven, or for approximately 1 to approximately 5 minutes on a hot plate. After that, in order to cure the coating film, heating treatment is carried out at approximately 180 to approximately 250° C., preferably at approximately 200 to approximately 250° C. for approximately 30 to approximately 90 minutes in an oven, or for approximately 5 to approximately 30 minutes on a hot plate.

When cured by heating after photopolymerization, heating conditions vary depending on the type of each component and each blending ratio. In general, drying is carried out at approximately 70 to approximately 120° C. for approximately 5 to approximately 15 minutes in an oven, or for approximately 1 to approximately 5 minutes on a hot plate, and after that, irradiation is carried out with a light having a wavelength in the range from the ultraviolet region to the visible light region (ultraviolet light is preferable). Regarding the amount of irradiation, 5 to 1,000 mJ/cm² of i-line is irradiated. At the end, in order to cure the coating film, heating treatment is carried out at approximately 180 to approximately 250° C., preferably at approximately 200 to approximately 250° C. for approximately 30 to approximately 90 minutes in an oven, or for approximately 5 to approximately 30 minutes on a hot plate to obtain the cured film.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

Hereinafter, the invention will be described in detail by way of Synthesis Examples, Examples and Comparative Examples. The invention is not limited by these examples.

First, a solution of polyester amide acid (A) including a reaction product of a tetracarboxylic dianhydride (a1), a diamine (a2) and a multivalent hydroxy compound (a3) was synthesized as described below.

### Synthesis Example 1

Into a 500 ml four-neck flask equipped with a thermometer, a stirrer, a raw material feed port and a nitrogen gas inlet, 180 g of dehydrated and purified 1,3-dimethyl-2-imidazolidinone (hereinafter abbreviated as “DMI”), 13 g of 1,4-butanediol, 10 g of benzyl alcohol and 74 g of 3,3′,4,4′-diphenylether tetracarboxylic dianhydride (hereinafter abbreviated as “ODPA”) were put, and the mixture was stirred under a dry nitrogen gas stream at 130° C. for 3 hours. After that, the reaction solution was cooled to 25° C., 11 g of 3,3′-diaminodiphenyl sulfone (hereinafter abbreviated as “DDS”) and 72 g of DMI were added to the reaction solution and the mixture was stirred at 20 to 30° C. for 2 hours. After that, the mixture was stirred at 115° C. for 1 hour and cooled to 30° C. or lower, thereby obtaining 30 wt % polyester amide acid solution which was pale yellow and transparent.

### Synthesis Example 2

Into a 500 ml four-neck flask equipped with a thermometer, a stirrer, a raw material feed port and a nitrogen gas inlet, 270 g of dehydrated and purified dipropylene glycol methyl ether acetate (hereinafter abbreviated as “DMPA”), 13 g of ODPA, 39 g of SMA1000P (trade name; styrene-maleic anhydride copolymer, manufactured by Kawahara Yuka Co., Ltd.), 15 g of benzyl alcohol, and 2.5 g of 1,4-butanediol were put in this order, and the mixture was stirred under a dry nitrogen gas stream at 130° C. for 3 hours. After that, the reaction solution was cooled to 25° C., 2.5 g of DDS and 18 g of DPMA were added to the reaction solution, and the mixture was stirred at 20 to 30° C. for 2 hours. After that, the mixture was stirred at 115° C for 1 hour and cooled to 30° C. or lower, thereby obtaining 20 wt % polyester amide acid solution which was pale yellow and transparent.

### Synthesis Example 3

Into a 500 ml four-neck flask equipped with a thermometer, a stirrer, a raw material feed port and a nitrogen gas inlet, 316 g of dehydrated and purified DPMA, 11 g of acrylic acid, 22 g of glycidyl acrylate, 14 g of (3-ethyl-3-oxetanyl)methyl acrylate, and 25 g of benzyl methacrylate, 7 g of Dimethyl 2,2′-azobis(2-methylpropionate) were put, and the mixture was stirred at 90° C. under a dry nitrogen gas stream for 4 hours. After that, the mixture was cooled to 30° C. or lower to obtain 20 wt % acrylic copolymer solution.

Next, ink-jet ink compositions were prepared using the polyester amide acids (A) obtained in Synthesis Examples 1 and 2 and the acrylic copolymer obtained in Synthesis Example 3 (Examples 1-3, Comparative Examples 1 and 2), and their contact angle, jetting characteristics, heat resistance, chemical resistance and voltage retention rate were evaluated according to the following method.

Method for Evaluating Contact Angles

Black ink, whose formulation will be described below, was applied to a transparent glass substrate by means of the spin coat method. After that, it was prebaked on a hot plate at 80° C. for 3 minutes to form a coating film. Next, the coating film was cured by heating in an oven at 230° C. for 30 minutes. After a cured film having the thickness of 1.0 μm was obtained, it was subjected to a hydrophobic treatment. This cured film was contacted with the ink-jet ink composition at room temperature. After 30 seconds, when the contact angle of the ink-jet ink composition was 50° or more, it is represented by “∘”, and when less than 50°, it is represented by “×.”

The black ink was prepared as follows. First, 5 g of Solsperse manufactured by The Lubrizol Corporation was dissolved in 20 g of DPMA. 30 g of C. I. Pigment Black 7 was added thereto, and the mixture was kneaded using a three-roll mill. After that, 50 g of DPMA and 400 g of zirconia beads having the diameter of 0.5 mm were added thereto, and the mixture was stirred for 20 hours using a sand mill. The obtained solution was filtered using a membrane filter made of Teflon® having the pore diameter of 1 μm to obtain 100 g of black dispersion liquid. Next, a 300 ml separable flask equipped with a stirring blade was subjected to nitrogen substitution, and into this flask, 57 g of the acrylic copolymer solution obtained in Synthesis Example 3, the whole black dispersion liquid, 7 g of N-cyclohexylmaleimide-glycidyl methacrylate copolymer (the weight ratio: 20:80), 1.9 g of 3-glycidoxypropyl methyldimethoxysilane, and 0.15 g of Byk-344 (trade name; manufactured by BYK-Chemie GmbH) were put, and the mixture was stirred at room temperature for 1 hour. After that, the mixture was filtered using a membrane filter having the pore diameter of 0.5 μm to prepare the black ink.

Method for Evaluating Jetting Characteristics

The ink-jet ink composition was applied to a glass substrate at 30° C. with a discharge voltage of 16 V using a DMP-2800 type head for 10 pl manufactured by FUJIFILM Dimatix, Inc. to form dot patterns. When liquid columns at the time of jetting were discharged in the vertical direction and no satellite ink drop was generated, it is represented by “∘”, and when a liquid column was in contact with an adjacent liquid column, or when satellite ink drops were generated, it is represented by “×.”

Method for Evaluating Heat Resistance

The ink-jet ink composition was applied to a transparent glass substrate by means of the spin coat method, and thereafter it was prebaked on a hot plate at 80° C. for 3 minutes to form a coating film. After that, the coating film was cured by heating in an oven at 230° C. for 30 minutes to obtain a cured film having the thickness of 1.5 μm.

The film was further reheated at 250° C. for 1 hour. After that, the film remaining ratio and the color difference (ΔE) after reheating were evaluated by means of comparison with the film thickness and the color purity of the film before reheating. When the film remaining ratio after heating was 97% or higher, it is represented by “∘”, and when the ratio was less than 97%, it is represented by “×.” When the color difference was less than 1, it is represented by “∘”, and when the color difference was 1 or more, it is represented by “×.”

The measurement of the film remaining ratio was carried out using a highly sensitive surface profiler (trade name: P-15, manufactured by KLATENCOR Corporation). The measurement of the color purity was carried out using a spectrophotometer (trade name: MICRO COLOR ANALYZER TC-1800M, manufactured by Tokyo Denshoku Technical Center Company Ltd.).

Method for Evaluating Chemical Resistance

As in the case of the evaluation of heat resistance, a cured film having the thickness of 1.5 μm was formed on a transparent glass substrate. The below-described treatments are independently applied to the cure film. After that, as in the case of the evaluation of heat resistance, the film remaining ratio after each treatment was measured for comparison with the film thickness before each treatment. When the film remaining ratio after each treatment was 95% or higher, it is represented by “∘”, and when the film remaining ratio after each treatment was less than 95%, it is represented by “×.”
IPA treatment: immersed in isopropyl alcohol at 50° C. for 30 minutes
NMP treatment: immersed in N-methyl-2-pyrrolidone at 50° C. for 30 minutes
GBL treatment: immersed in γ-butyrolactone at 50° C. for 30 minutes

Method for Evaluating Voltage Retention Rate

As in the case of the evaluation of heat resistance, the ink-jet ink composition was applied to a transparent glass substrate by means of the spin coat method, and thereafter it was prebaked on a hot plate at 80° C. for 3 minutes to form a coating film. After that, the coating film was cured by heating in an oven at 230° C. for 30 minutes to obtain a cured film having the thickness of 1.5 μm.

The cured film was scraped away from the glass substrate. This was mixed with a liquid crystal composition (JC-5044XX, manufactured by Chisso Corporation) so that the amount of the cured film was 1.5 wt %. Immersion was performed at 60° C. for 48 hours to prepare a sample for the measurement of the voltage retention rate. The sample was filtered using a membrane filter made of Teflon® having the pore diameter of 0.2 μm.

A liquid crystal cell was produced as follows. An aligning agent (PIA-5550, manufactured by Chisso Corporation) was applied to transparent glass substrates (10 cm×10 cm), to one surface of which ITO electrode was provided, by means of the spin coat method. After they were dried at 100° C. for 10 minutes, they were treated in an oven at 250° C. for 90 minutes to obtain substrates coated with an aligning film having the thickness of approximately 0.06 μm. The aligning film surfaces of the two substrates were independently subjected to the rubbing treatment. On one of the substrates, bead spacers having the diameter of approximately 6 μm were spread. The other substrate was attached to the aforementioned substrate using an epoxy-based seal material (LC Structbond manufactured by Mitsui Chemicals, Inc.) so that the rubbing directions of the substrates were parallel to each other and the substrates were opposed to each other. The mixture of the cured film and the liquid crystal was included therein. After the inclusion, it was subjected to an isotropic treatment at 120° C. for 30 minutes, and was slowly cooled to room temperature to obtain a liquid crystal cell.

Using an LC Material Characteristics Measurement System Model 6254 manufactured by TOYO Corporation, a drain of the liquid crystal cell, which was changed by applying a rectangular wave (gate pulse width: 60 μs, frequency: 0.3 Hz, wave height: ±5V) to a source at 60° C., was read by an oscilloscope. This was performed 4 times to obtain the average value. When the voltage retention rate was 95% or higher, it is represented by “∘”, and when the rate was less than 95%, it is represented by “×.”

### Example 1

5 g of Solsperse manufactured by The Lubrizol Corporation was dissolved in 20 g of DPMA. 12 g of C. I. Pigment Red 254 and 3 g of C. I. Pigment Yellow 139 were added thereto and the mixture was kneaded using a three-roll mill. After that, 40 g of DPMA and 400 g of zirconia beads having the diameter of 0.5 mm were added thereto, and the mixture was stirred using a sand mill for 20 hours. The obtained liquid was filtered using a membrane filter made of Teflon® having the pore diameter of 1 μm to obtain 75 g of a red dispersion liquid.

A 300 ml separable flask equipped with a stirring blade was subjected to nitrogen substitution, and into this flask, 28 g of the polyester amide acid solution obtained in Synthesis Example 1, the whole red dispersion liquid, 2.6 g of TECHMORE VG3101L (trade name, manufactured by Mitsui Chemicals, Inc.), 1.4 g of 3-glycidoxypropyl methyldimethoxysilane, and 0.1 g of Byk-344 (trade name; manufactured by BYK-Chemie GmbH) were put, and the mixture was stirred at room temperature for 1 hour. After that, the mixture was filtered using a membrane filter having the pore diameter of 0.5 μm to prepare an ink-jet ink composition. The viscosity of the ink-jet ink composition was 15.3 mPa·s. The value of the viscosity was obtained by a measurement at 25° C. using an E type viscometer (trade name: VISCONIC END, manufactured by Tokyo Keiki Co., Ltd.) (the same applies to the following). The viscosity of the ink-jet ink composition at 30° C. was 13.0 mPa·s.

First, the contact angle between the film of hydrophobic black ink cured on the glass substrate and the ink-jet ink composition was evaluated. The results of the evaluation are shown in Table 1.

Further, jetting characteristics of the ink-jet ink composition were evaluated. The ink-jet ink composition was applied to a glass substrate using a piezojet-type head to form dot patterns. Liquid columns at the time of jetting were discharged in the vertical direction and no satellite ink drop was generated.

Next, the ink-jet ink composition was spin-coated to a glass substrate at 750 rpm for 10 seconds. After that, it was prebaked on a hot plate at 80° C. for 3 minutes to form a coating film. After that, it was heated in an oven at 230° C. for 30 minutes to obtain a cured coating film. Regarding the cured film thus obtained, the thickness, heat resistance, chemical resistance and voltage retention rate were evaluated. The results of the evaluation are shown in Table 1.

### Example 2

5 g of Solsperse manufactured by The Lubrizol Corporation was dissolved in 20 g of DPMA. 12 g of C. I. Pigment Green 36 and 8 g of C. I. Pigment Yellow 150 were added thereto, and the mixture was kneaded using a three-roll mill. After that, 40 g of DPMA and 400 g of zirconia beads having the diameter of 0.5 mm were added thereto, and the mixture was stirred using a sand mill for 20 hours. The obtained solution was filtered using a membrane filter made of Teflon® having the pore diameter of 1 μm to obtain 80 g of green dispersion liquid.

A 300 ml separable flask equipped with a stirring blade was subjected to nitrogen substitution, and into this flask, 54 g of the polyester amide acid solution obtained in Synthesis Example 2, the whole green dispersion liquid, 7 g of N-cyclohexylmaleimide-glycidyl methacrylate copolymer (the weight ratio: 20:80), 1.9 g of 3-glycidoxypropyl methyldimethoxysilane, and 0.15 g of Byk-344 (trade name; manufactured by BYK-Chemie GmbH) were put, and the mixture was stirred at room temperature for 1 hour. After that, the mixture was filtered using a membrane filter having the pore diameter of 0.5 μm to prepare an ink-jet ink composition. The viscosity of the ink-jet ink composition (25° C.) was 14.1 mPa·s. The viscosity of the ink-jet ink composition at 30° C. was 11.9 mPa·s.

The contact angle, jetting characteristics, the thickness of the cured film, the heat resistance, the chemical resistance and the voltage retention rate were evaluated in a manner similar to that in Example 1. The results of the evaluation are shown in Table 1.

### Example 3

5 g of Solsperse manufactured by The Lubrizol Corporation was dissolved in 20 g of DPMA. 20 g of C. I. Pigment Blue 15:6 was added thereto, and the mixture was kneaded using a three-roll mill. After that, 60 g of DPMA and 400 g of zirconia beads having the diameter of 0.5 mm were added thereto, and the mixture was stirred using a sand mill for 20 hours. The obtained liquid was filtered using a membrane filter made of Teflon® having the pore diameter of 1 μm to obtain 100 g of blue dispersion liquid.

A 300 ml separable flask equipped with a stirring blade was subjected to nitrogen substitution, and into this flask, 35 g of the polyester amide acid solution obtained in Synthesis Example 1, the whole blue dispersion liquid, 7 g of N-cyclohexylmaleimide-glycidyl methacrylate copolymer (the weight ratio: 20:80), 1.8 g of 3-glycidoxypropyl methyldimethoxysilane and 0.15 g of Byk-344 (trade name; manufactured by BYK-Chemie GmbH) were put, and the mixture was stirred at room temperature for 1 hour. After that, the mixture was filtered using a membrane filter having the pore diameter of 0.5 μm to prepare an ink-jet ink composition. The viscosity of the ink-jet ink composition (25° C.) was 14.6 mPa·s. The viscosity of the ink-jet ink composition at 30° C. was 12.4 mPa·s.

The contact angle, jetting characteristics, the thickness of the cured film, the heat resistance, the chemical resistance and the voltage retention rate were evaluated in a manner similar to that in Example 1. The results of the evaluation are shown in Table 1.

### Comparative Example 1

5 g of Solsperse manufactured by The Lubrizol Corporation was dissolved in 20 g of DPMA. 12 g of C. I. Pigment Green 36 and 8 g of C. I. Pigment Yellow 150 were added thereto and the mixture was kneaded using a three-roll mill. After that, 40 g of DPMA and 400 g of zirconia beads having the diameter of 0.5 mm were added thereto, and the mixture was stirred using a sand mill for 20 hours. The obtained solution was filtered using a membrane filter made of Teflon® having the pore diameter of 1 μm to obtain 80 g of green dispersion liquid.

A 300 ml separable flask equipped with a stirring blade was subjected to nitrogen substitution, and into this flask, 57 g of the acrylic copolymer solution obtained in Synthesis Example 3, the whole green dispersion liquid, 3.5 g of TECHMORE VG3101L (trade name, manufactured by Mitsui Chemicals, Inc.), 1.9 g of 3-glycidoxypropyl methyldimethoxysilane and 0.15 g of Byk-344 (trade name, manufactured by BYK-Chemie GmbH) were put, and the mixture was stirred at room temperature for 1 hour. After that, the mixture was filtered using a membrane filter having the pore diameter of 0.5 μm to prepare an ink-jet ink composition. The viscosity of the inkjet ink composition (25° C.) was 12.8 mPa·s. The viscosity of the ink-jet ink composition at 30° C. was 10.8 mPa·s.

The contact angle, jetting characteristics, the thickness of the cured film, the heat resistance, the chemical resistance and the voltage retention rate were evaluated in a manner similar to that in Example 1. The results of the evaluation are shown in Table 1.

### Comparative Example 2

5 g of Solsperse manufactured by The Lubrizol Corporation was dissolved in 20 g of DPMA. 12 g of C. I. Pigment Green 36 and 8 g of C. I. Pigment Yellow 150 were added thereto, and the mixture was kneaded using a three-roll mill. After that, 40 g of DPMA and 400 g of zirconia beads having the diameter of 0.5 mm were added thereto, and the mixture was stirred using a sand mill for 20 hours. The obtained solution was filtered using a membrane filter made of Teflon® having the pore diameter of 1 μm to obtain 80 g of green dispersion liquid.

A 300 ml separable flask equipped with a stirring blade was subjected to nitrogen substitution, and into this flask, 40 g of the polyester amide acid solution obtained in Synthesis Example 1, the whole green dispersion liquid, 3.45 g of Araldite CY184 (trade name, manufactured by Vantico AG), 1.9 g of 3-glycidoxypropyl methyldimethoxysilane, 0.15 g of Byk-344 (trade name, manufactured by BYK-Chemie GmbH) and 19.55 g of DPMA were put, and the mixture was stirred at room temperature for 1 hour. After that, the mixture was filtered using a membrane filter having the pore diameter of 0.5 μm to prepare an ink-jet ink composition. The viscosity of the ink-jet ink composition (25° C.) was 13.9 mPa·s. The viscosity of the ink-jet ink composition at 30° C. was 11.8 mPa·s.

The contact angle, jetting characteristics, the thickness of the cured film, the heat resistance, the chemical resistance and the voltage retention rate were evaluated in a manner similar to that in Example 1. The results of the evaluation are shown in Table 1.

TABLE 1

| | | | | | Comparative | Comparative |
|---|---|---|---|---|---|---|
| | | Example 1 | Example 2 | Example 3 | Example 1 | Example 2 |
| Polyester amide acid | | Synthesis | Synthesis | Synthesis | Synthesis | Synthesis |
| (A) | | Example 1 | Example 2 | Example 1 | Example 3 | Example 1 |
| Pigment (B) | | Red | Green | Blue | Green | Green |
| Epoxy resin (C) | | VG3101L | Copolymer A | Copolymer A | VG3101L | CY184 |
| Contact angle | | ∘ | ∘ | ∘ | ∘ | ∘ |
| Jetting characteristics | | ∘ | ∘ | ∘ | ∘ | ∘ |
| Film thickness (μm) | | 1.51 | 1.53 | 1.48 | 1.51 | 1.49 |
| Heat | Film | ∘ | ∘ | ∘ | ∘ | x |
| Resistance | remaining | | | | | |
| | ratio | | | | | |
| | ΔE | ∘ | ∘ | ∘ | ∘ | x |
| Chemical | IPA | ∘ | ∘ | ∘ | ∘ | x |
| Resistance | NMP | ∘ | ∘ | ∘ | x | x |
| | GBL | ∘ | ∘ | ∘ | x | ∘ |

| | | | | | |
|---|---|---|---|---|---|
| Voltage retention rate | ∘ | ∘ | ∘ | x | ∘ |

VG3101L: TECHMORE VG3101L manufactured by Mitsui Chemicals, Inc.
Copolymer A:N-cyclohexylmaleimide-glycidyl methacrylate copolymer (the weight ratio: 20:80)
CY184: Araldite CY184 manufactured by Vantico AG

As is obvious from the results shown in Table 1, the cured films in Examples 1 to 3 are excellent in chemical resistance and heat resistance. On the other hand, the inkjet ink composition comprising the acrylic copolymer solution in Comparative Example 1 is inferior in heat resistance. The ink-jet ink composition comprising the bifunctional epoxy resin in Comparative Example 2 is inferior in chemical resistance.

### INDUSTRIAL APPLICABILITY

The composition of the invention comprising a polyester amide acid can be used as an ink-jet ink composition, which is excellent in ink-jetting characteristics, and which forms a color filter that is excellent in chemical resistance and heat resistance.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A composition comprising a polyester amide acid (A) obtained by reacting a tetracarboxylic dianhydride (a1), a diamine (a2) and a multivalent hydroxy compound (a3); and a pigment (B).

2. A composition comprising a polyester amide acid (A) obtained by reacting a tetracarboxylic dianhydride (a1), a diamine (a2) and a multivalent hydroxy compound (a3); a pigment (B); and an epoxy resin (C).

3. The composition according to claim 1, further comprising a compound (D) having a polymerizable double bond; and a photopolymerization initiator (E).

4. The composition according to claim 1, further comprising a solvent (G) having a boiling point of approximately 200° C. or higher.

5. The composition according to claim 1, wherein the polyester amide acid (A) is a reaction product obtained by further reacting a monovalent alcohol (a4) as a raw material.

6. The composition according to claim 1, wherein the polyester amide acid (A) is a reaction product obtained by further reacting a styrene-maleic anhydride copolymer (a5) and/or a silicon-containing monoamine (a6) as raw materials.

7. The composition according to claim 1, wherein the polyester amide acid (A) is obtained by reacting X moles of the tetracarboxylic dianhydride (a1), Y moles of the diamine (a2) and Z moles of the multivalent hydroxy compound (a3) in a ratio which satisfies relationships defined by the following mathematical formulae (1) and (2):
approximately 0.2≦Z/Y≦approximately 8.0 (1)
approximately 0.2≦(Y+Z)/X≦approximately 1.5 (2)

8. The composition according to claim 1, wherein the polyester amide acid (A) is a compound having constitutional units represented by the following structural formulae (1) and (2): 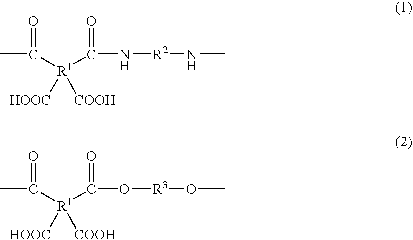
wherein R¹ is a residue of the tetracarboxylic dianhydride (a1), R² is a residue of the diamine (a2) and R³ is a residue of the multivalent hydroxy compound (a3).

9. The composition according to claim 2, wherein the epoxy resin (C) is one or more compound(s) selected from: a homopolymer of a monomer having an epoxy group; a copolymer of two or more monomers having an epoxy group; and a copolymer of a monomer having an epoxy group and a monomer having no epoxy group.

10. The composition according to claim 2, wherein the epoxy resin (C) is one or more compound(s) selected from: a bisphenol A type epoxy resin, a glycidyl ester type epoxy resin, an alicyclic epoxy resin, a glycidyl ether type epoxy resin, a bisphenol A novolac type epoxy resin, a phenol novolac type epoxy resin, a cresol novolac type epoxy resin, and a copolymer of a monomer having an epoxy group and a N-substituted maleimide compound.

11. The composition according to claim 2, wherein the epoxy resin (C) is a compound selected from: a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol; and 2-[4-(2,3-epoxy propoxy)phenyl]-2-[4-[1,1-bis[4-([2,3-epoxy propoxy]phenyl)]ethyl]phenyl]propane.

12. The composition according to claim 1, wherein the composition is an ink-jet ink composition.

13. A color filter produced using the ink-jet ink composition according to claim 12.

14. A liquid crystal display device comprising the color filter according to claim 13.

15. A solid-state image sensing device comprising the color filter according to claim 13.

16. The composition according to claim 2, further comprising a compound (D) having a polymerizable double bond; and a photopolymerization initiator (E).

17. The composition according to claim 2, further comprising a solvent (G) having a boiling point of approximately 200° C. or higher.

18. The composition according to claim 2, wherein the polyester amide acid (A) is a reaction product obtained by further reacting a monovalent alcohol (a4) as a raw material.

19. The composition according to claim 2, wherein the polyester amide acid (A) is a reaction product obtained by further reacting a styrene-maleic anhydride copolymer (a5) and/or a silicon-containing monoamine (a6) as raw materials.

20. The composition according to claim 2, wherein the polyester amide acid (A) is obtained by reacting X moles of the tetracarboxylic dianhydride (a1), Y moles of the diamine (a2) and Z moles of the multivalent hydroxy compound (a3) in a ratio which satisfies relationships defined by the following mathematical formulae (1) and (2):
approximately 0.2≦Z/Y≦approximately 8.0 (1)
approximately 0.2≦(Y+Z)/X≦approximately 1.5 (2)

21. The composition according to claim 2, wherein the polyester amide acid (A) is a compound having constitutional units represented by the following structural formulae (1) and (2): 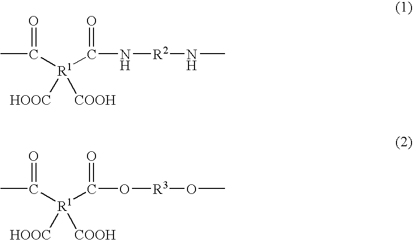
wherein R¹ is a residue of the tetracarboxylic dianhydride (a1), R² is a residue of the diamine (a2) and R³ is a residue of the multivalent hydroxy compound (a3).

22. The composition according to claim 2, wherein the composition is an ink-jet ink composition.

23. A color filter produced using the ink-jet ink composition according to claim 22.

24. A liquid crystal display device comprising the color filter according to claim 23.

25. A solid-state image sensing device comprising the color filter according to claim 23.
